(19) United States
(12) Patent Application Publication
(10) Pub. No.: US 2021/0172477 A1
(43) Pub. Date: Jun. 10, 2021

(54) CAGE, RADIAL-THRUST INTEGRATED BEARING, AND PLANETARY GEAR DEVICE

(71) Applicant: JTEKT CORPORATION, Osaka (JP)

(72) Inventor: Kotaro YAMASHITA, Kashiwara-shi (JP)

(73) Assignee: JTEKT CORPORATION, Osaka (JP)

(21) Appl. No.: 17/109,295

(22) Filed: Dec. 2, 2020

(30) Foreign Application Priority Data
Dec. 6, 2019 (JP) 2019-221414

(51) Int. Cl. F16C 33/58; F16H 1/28

(52) U.S. Cl. CPC F16C 33/581; F16H 1/28; F16H 2001/289; F16H 2001/2872; F16C 2361/61

(57) ABSTRACT

A cage includes: a first holding portion in which a plurality of radial rollers is held; a second holding portion in which a plurality of thrust rollers is held; and a connecting portion via which the first holding portion is connected to the second holding portion. The first holding portion, the second holding portion, and the connecting portion are molded integrally by a resin member.

### CROSS-REFERENCE TO RELATED APPLICATION

This application claims priority to Japanese Patent Application No. 2019-221414 filed on Dec. 6, 2019, incorporated herein by reference in its entirety.

### BACKGROUND

### 1. Technical Field

The present disclosure relates to a cage, a radial-thrust integrated bearing, and a planetary gear device.

### 2. Description of Related Art

In the related art, some planetary gear devices used in vehicles are, for example, configured such that a plurality of planetary gears is placed between an external gear and an internal gear, and each of the planetary gears is rotatably supported by a roller bearing. A planetary gear device described in Japanese Unexamined Patent Application Publication No. 7-103320 (JP 7-103320 A) is configured such that a radial roller bearing is placed between an outer peripheral surface of a support shaft (a pinion shaft) of a carrier and an inner peripheral surface of a shaft hole of a planetary gear.

Further, the applicants of this application have proposed that a thrust roller bearing is placed between an axial end surface of a planetary gear and a side wall of a carrier in addition to a radial roller bearing so as to further reduce a rotational resistance of the planetary gear (e.g., see Japanese Unexamined Patent Application Publication No. 2012-47225 (JP 2012-47225 A)). The thrust roller bearing described in JP 2012-47225 A includes a plurality of thrust rollers, a thrust cage in which the thrust rollers are held, and a thrust bearing ring including a raceway portion having a raceway surface on which the thrust rollers roll. The thrust bearing ring includes: an attachment portion extending axially outwardly from an outer peripheral portion of the raceway portion and attached to an outer peripheral portion of the carrier; and a cage guide portion extending axially inwardly from the outer peripheral portion of the raceway portion and making sliding contact with an outer peripheral surface of the thrust cage so as to guide the thrust cage in a rotating manner. The thrust cage is supported by the cage guide portion and is placed such that an inner peripheral surface of the thrust cage radially faces, via a gap, an outer peripheral surface of a radial cage of the radial roller bearing. This configuration prevents the radial cage and the thrust cage from being damaged by making contact with each other.

### SUMMARY

In the planetary gear device described in JP 2012-47225 A, in order to prevent contact between the thrust cage and the radial cage, the thrust bearing ring that supports the thrust cage is required, and this accordingly increases the number of components and the number of man-hours for assembly.

The present disclosure provides a cage in which a plurality of radial rollers and a plurality of thrust rollers are held, the cage being able to restrain an increase in the number of components and the number of man-hours for assembly, a radial-thrust integrated bearing including the cage, and a planetary gear device including the radial-thrust integrated bearing.

A first aspect of the present disclosure relates to a cage including a first holding portion, a second holding portion, and a connecting portion. A plurality of radial rollers is held in the first holding portion. A plurality of thrust rollers is held in the second holding portion. The first holding portion is connected to the second holding portion via the connecting portion. The first holding portion, the second holding portion, and the connecting portion are molded integrally by a resin member.

Further, a second aspect of the present disclosure relates to a radial-thrust integrated bearing including the cage, the radial rollers held in the first holding portion, and the thrust rollers held in the second holding portion.

Further, a third aspect of the present disclosure relates to a planetary gear device including a sun gear, an internal gear, a plurality of planetary gears, and a carrier. The sun gear has external teeth provided on an outer peripheral surface of the sun gear. The internal gear has internal teeth provided on an inner peripheral surface of the internal gear. The planetary gears are placed between the sun gear and the internal gear. The carrier is configured to support the planetary gears. The planetary gears are supported by the radial-thrust integrated bearing such that the planetary gears are rotatable to the carrier.

With the cage, the radial-thrust integrated bearing, and the planetary gear device according to the above aspects of the present disclosure, it is possible to restrain an increase in the number of components and the number of man-hours for assembly.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view illustrating a planetary gear device using a radial-thrust integrated bearing including a cage according to an embodiment of the present disclosure;

FIG. 2A is a sectional view illustrating a section of the radial-thrust integrated bearing together with its peripheral portion;

FIG. 2B is a sectional view taken along a line II-II in FIG. 2A;

FIG. 3 is a side view illustrating the radial-thrust integrated bearing;

FIG. 4A is a sectional view taken along a line IVA-IVA in FIG. 3;

FIG. 4B is a sectional view taken along a line IVB-IVB in FIG. 3; and

FIG. 5 is a perspective view illustrating the cage of the radial-thrust integrated bearing.

### DETAILED DESCRIPTION OF EMBODIMENTS

### Embodiment

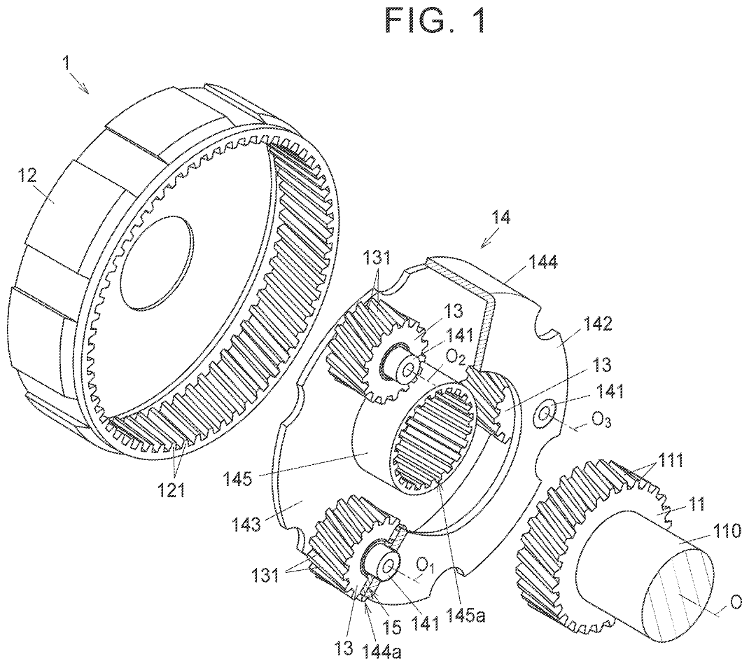

An embodiment of the present disclosure will be described below with reference to FIGS. 1 to 5. Note that the embodiment described below indicates a preferred concrete example on performing the present disclosure. There are some parts that specifically show various technical matters that are technically preferable, but a technical scope of the present disclosure is not limited to such a concrete example.

Overall Configuration of Planetary Gear Device

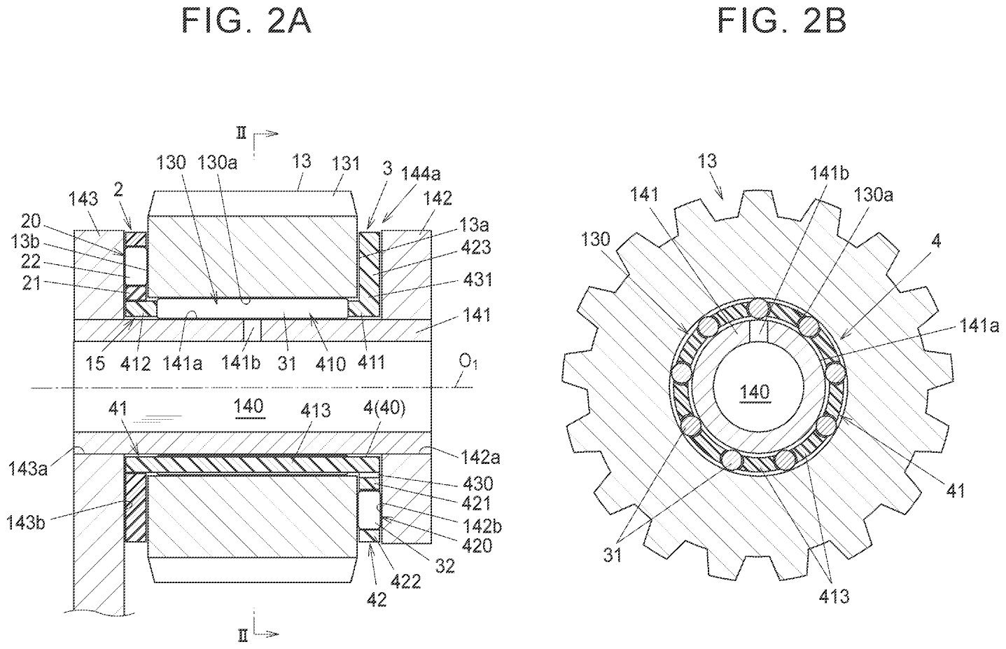

FIG. 1 is an exploded perspective view illustrating a planetary gear device using a radial-thrust integrated bearing including a cage according to an embodiment of the present disclosure. FIG. 2A is a sectional view illustrating a section of the radial-thrust integrated bearing together with its peripheral portion, and FIG. 2B is a sectional view taken along a line II-II in FIG. 2A.

The planetary gear device 1 includes: a sun gear 11 having external teeth 111 on its outer peripheral surface; an internal gear 12 having internal teeth 121 on its inner peripheral surface; a plurality of (three in the present embodiment) planetary gears 13 placed between the sun gear 11 and the internal gear 12; a carrier 14 including a plurality of (three) support shafts 141 configured to support the planetary gears 13, respectively; and a combined bearing device 15 (see FIG. 2A) placed between each of the planetary gears 13 and its corresponding one of the support shafts 141. The planetary gear 13 includes external teeth 131 meshing with the external teeth 111 of the sun gear 11 and the internal teeth 121 of the internal gear 12.

The sun gear 11, the internal gear 12, and the carrier 14 are supported to be coaxially rotatable relative to each other on a rotation axis O. Further, the planetary gears 13 rotate on respective rotation axes O₁ to O₃ around the support shafts 141. The planetary gears 13 revolve around the rotation axis O and rotate on the respective rotation axes O₁ to O₃. In FIGS. 2A, 2B, one planetary gear 13 rotating on the rotation axis O₁ is illustrated. Hereinafter, a direction parallel to the rotation axis O₁ is referred to as an axial direction, and a direction perpendicular to the rotation axis O₁ is referred to as a radial direction.

A shaft 110 is fixed to a central part of the sun gear 11 in a relatively non-rotatable manner. The planetary gear 13 is configured such that the support shaft 141 is passed through a shaft hole 130 penetrating through a central part of the planetary gear 13. The carrier 14 supports the planetary gears 13 via the combined bearing devices 15 such that the planetary gears 13 can rotate and revolve. Further, the carrier 14 includes first and second disk portions 142, 143 between which the planetary gears 13 are sandwiched in the axial direction, an outer wall portion 144 configured to bridge respective end parts, on the outside-diameter side, of the first and second disk portions 142, 143, and a fitting cylinder 145 fixed to an end part, on the inside-diameter side, of the second disk portion 143.

A spline portion 145a to which a shaft (not shown) is fitted in a relatively non-rotatable manner is formed on the inner periphery of the fitting cylinder 145. An opening 144a is formed on the outer wall portion 144 such that part of the planetary gear 13 projects from the opening 144a. The external teeth 131 of the planetary gear 13 thus projecting from the opening 144a mesh with the internal teeth 121 of the internal gear 12.

As illustrated in FIG. 2A, both end parts of the support shaft 141 are fitted by pressing into fitting holes 142a, 143a formed in the first and second disk portions 142, 143. The support shaft 141 has a cylindrical shape having a cavity 140 formed in its central part. An oil hole 141b communicating with the cavity 140 is opened on an outer peripheral surface 141a. Lubricant flowing into the cavity 140 is supplied to the combined bearing device 15 from the oil hole 141b.

The planetary gear 13 is configured such that a first axial end surface 13a facing a disk surface 142b of the first disk portion 142 of the carrier 14 and a second axial end surface 13b facing a disk surface 143b of the second disk portion 143 of the carrier 14 are formed as flat surfaces perpendicular to the axial direction.

The combined bearing device 15 includes a thrust roller bearing 2 and a radial-thrust integrated bearing 3. The thrust roller bearing 2 is placed between the disk surface 143b of the second disk portion 143 of the carrier 14 and the second axial end surface 13b of the planetary gear 13. The thrust roller bearing 2 includes a cage 21 made of synthetic resin and including a plurality of pockets 20 formed in a radial manner, and a plurality of rollers 22 provided such that the rollers 22 are accommodated in the pockets 20, respectively. The rollers 22 roll on the disk surface 143b of the second disk portion 143 and the second axial end surface 13b of the planetary gear 13.

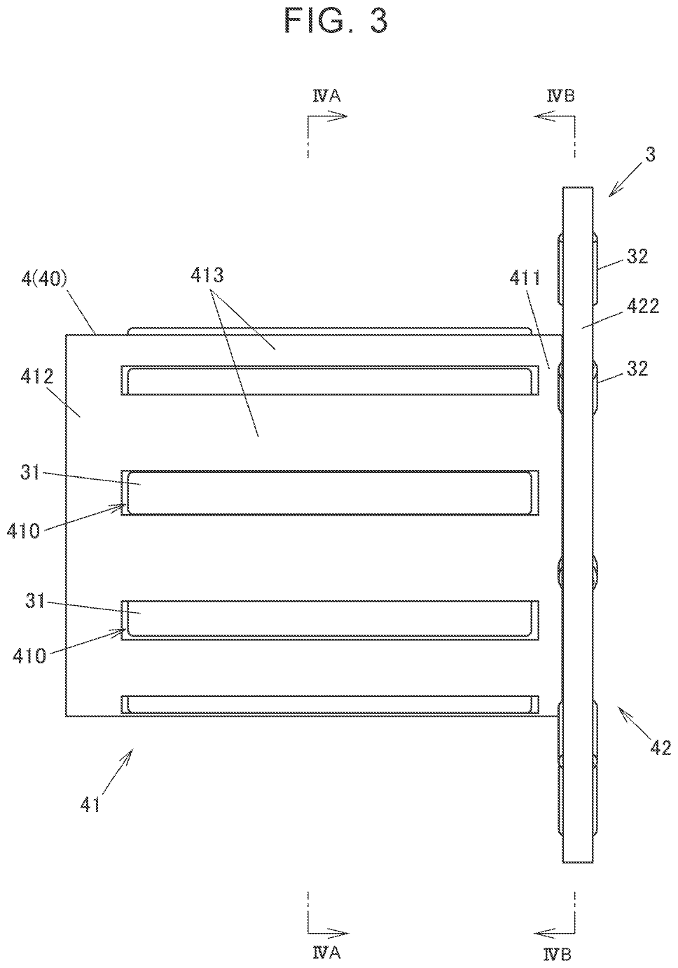

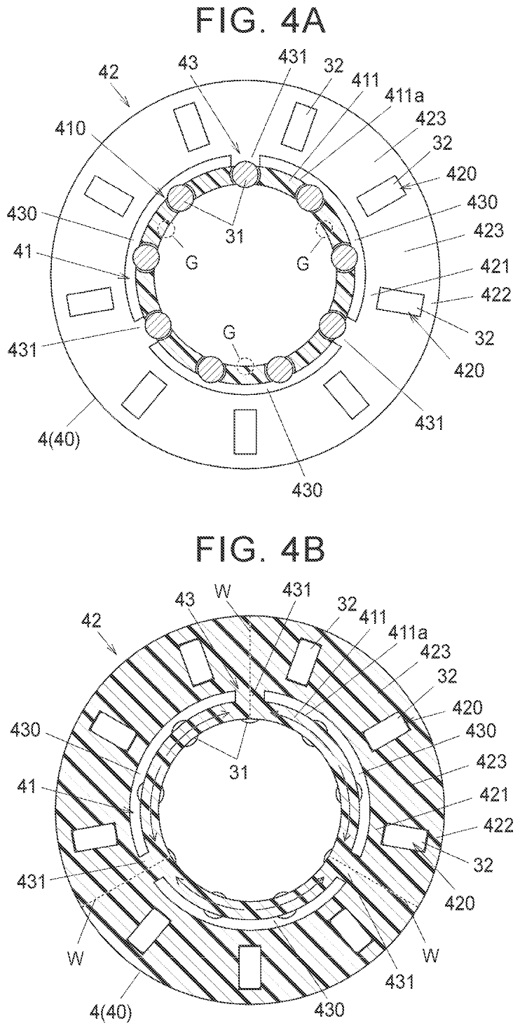

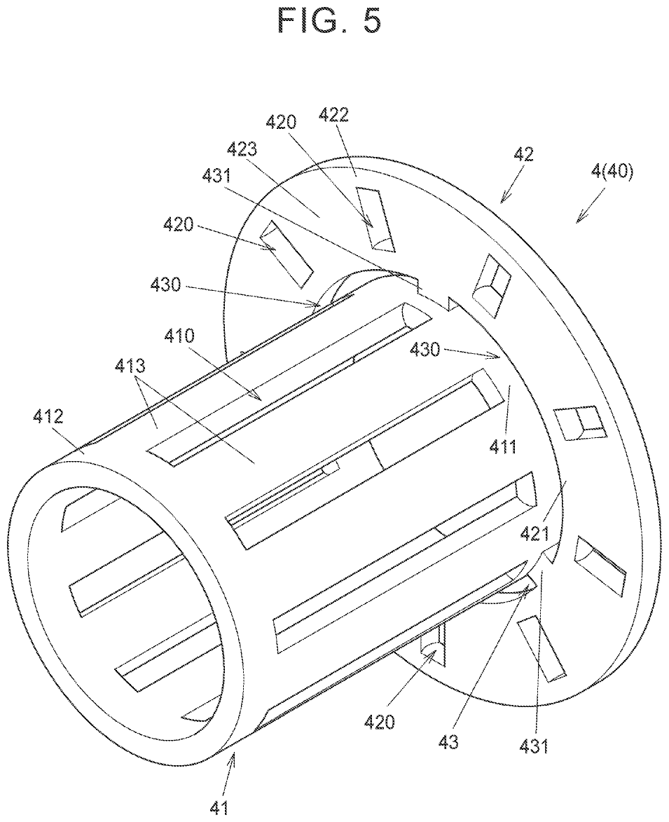

With reference to FIGS. 3 to 5, the following describes a configuration of the radial-thrust integrated bearing 3 in detail. FIG. 3 is a side view of the radial-thrust integrated bearing 3. FIG. 4A is a sectional view taken along a line IVA-IVA in FIG. 3, and FIG. 4B is a sectional view taken along a line IVB-IVB in FIG. 3. FIG. 5 is a perspective view illustrating a cage 4 of the radial-thrust integrated bearing 3.

The radial-thrust integrated bearing 3 includes: a plurality of radial rollers 31 placed between the outer peripheral surface 141a of the support shaft 141 and the inner peripheral surface 130a of the shaft hole 130 of the planetary gear 13; a plurality of thrust rollers 32 placed between the disk surface 142b of the first disk portion 142 of the carrier 14 and the first axial end surface 13a of the planetary gear 13; and the cage 4 including a resin member 40 formed by injection molding.

The cage 4 includes a first holding portion 41 in which the radial rollers 31 are held, a second holding portion 42 in which the thrust rollers 32 are held, and a connecting portion 43 via which the first holding portion 41 is connected to the second holding portion 42. The first holding portion 41, the second holding portion 42, and the connecting portion 43 are molded integrally by the resin member 40. More specifically, as a resin material for the resin member 40, nylon-66, polyphenylene sulfide (PPS) resin, polybutylene terephthalate (PBT) resin, or the like can be used preferably, for example. A reinforced fiber material such as glass fiber or carbon fiber may be added as needed.

The first holding portion 41 is defined by connecting a pair of annular bodies 411, 412 to each other in the axial direction by a plurality of columns 413. A plurality of pockets 410 is formed between the columns 413. The radial rollers 31 are accommodated in respective pockets 410 in a rotatable manner. In the present embodiment, nine pockets 410 are formed in the first holding portion 41, and nine radial rollers 31 are accommodated in the pockets 410, respectively.

The second holding portion 42 is defined by connecting an inner annular body 421 and an outer annular body 422 to each other in the radial direction by a plurality of columns 423. A plurality of pockets 420 is formed in a radial manner between the columns 423. The thrust rollers 32 are accommodated in respective pockets 420 in a rotatable manner. In the present embodiment, nine pockets 420 are formed in the second holding portion 42, and nine thrust rollers 32 are accommodated in the pockets 420, respectively. The columns 423 of the second holding portion 42 are provided in parts on the outer peripheral side from the pockets 410 of the first holding portion 41.

The connecting portion 43 is defined to project radially from an outer peripheral surface 411a of the first annular body 411 out of the annular bodies 411, 412 of the first holding portion 41. The first annular body 411 is placed on the first disk portion 142 side of the carrier 14. The annular body 411 is integrally connected to the inner annular body 421 via the connecting portion 43. The thrust roller bearing 2 is placed on the outer periphery of the second annular body 412.

The connecting portion 43 has a plurality of through holes 430 extending in the axial direction. In other words, the connecting portion 43 is constituted by a plurality of projections 431 projecting radially from the outer peripheral surface 411a of the annular body 411, and the through-holes 430 are formed between the projections 431.

In the present embodiment, the connecting portion 43 is constituted by three projections 431, and three through-holes 430 are formed in an arc shape in an axial view. Part of lubricant supplied from the oil hole 141b of the support shaft 141 flows to the outer periphery of the first holding portion 41 from the pockets 410 of the first holding portion 41 and further flows through the through-holes 430 in the axial direction, so that the part of the lubricant is supplied to the disk surface 142b side of the first disk portion 142.

The cage 4 is formed by injection molding by injecting molten resin into a metal mold. In the present embodiment, the cage 4 is formed such that the resin member 40 is molded by injecting molten resins into the cavity of the metal mold from three places of the first holding portion 41 at the same time. More specifically, the molten resins are injected from radially inner sides of three columns 413 among the nine columns 413. In FIG. 4A, a part corresponding to a gate via which the molten resin is injected is surrounded by a broken line and indicated by a reference sign G. Further, in FIG. 4B, the flows of the molten resins at the time of injection molding of the annular body 411 are indicated by arrows.

In meeting points of the molten resins, welds each indicated by a reference sign W in FIG. 4B are formed. Here, the weld is a joint-shaped part that is inevitably formed when the molten resins to join hit each other and is a part having a strength lower than other parts. In the present embodiment, three welds W extending linearly along the radial direction are formed in the resin member 40 at regular intervals (at every 120°) in the circumferential direction.

The welds W are formed over three parts, of the annular body 411, that are axially aligned with three pockets 410 among the nine pockets 410 of the first holding portion 41, the three projections 431, and three columns 423 among the nine columns 423 of the second holding portion 42. That is, the through-holes 430 of the connecting portion 43 are formed at positions deviating from the circumferential positions of the welds W, and the welds W are reinforced by the connecting portion 43 and the second holding portion 42. Hereby, in comparison with a case where the welds W are formed at positions corresponding to the through-holes 430 of the connecting portion 43, the strength of the cage 4 is increased.

The planetary gear device 1 is assembled in the following procedure, for example. That is, the radial-thrust integrated bearing 3 is placed on the outer periphery of the support shaft 141 fitted by pressing into the fitting hole 142a of the first disk portion 142, and the planetary gear 13 is placed on the outer periphery of the first holding portion 41 of the radial-thrust integrated bearing 3. Then, the thrust roller bearing 2 is placed on the outer periphery of the second annular body 412 of the first holding portion 41, and the support shaft 141 is fitted by pressing into the fitting hole 143a of the second disk portion 143. The outer wall portion 144 of the carrier 14 is integrated with the first disk portion 142, and by fixing a first axial end of the outer wall portion 144 to an end part, on the outer peripheral side, of the second disk portion 143 by welding, for example, the carrier 14 in which the planetary gears 13 are supported rotatably is obtained. The planetary gear device 1 is completed by combining the carrier 14 and the planetary gears 13 with the sun gear 11 and the internal gear 12.

### Effects of Embodiment

In the embodiment described above, the first holding portion 41 in which the radial rollers 31 are held and the second holding portion 42 in which the thrust rollers 32 are held are molded integrally by the resin member 40. Accordingly, while the rotation of the planetary gear 13 relative to the support shaft 141 is smoothly supported by the radial rollers 31 and the thrust rollers 32, it is possible to restrain an increase in the number of components and the number of man-hours for assembly in the planetary gear device 1. Further, the welds W are reinforced by the three projections 431 constituting the connecting portion 43, and the through-holes 430 are each formed between the projections 431. Hereby, it is possible to supply the lubricant to the thrust rollers 32 via the through-holes 430 and to restrain breakage of the cage 4 starting from the welds W.

Additional Matters

The present disclosure has been described based on the embodiment and its modification, but the embodiment and modification described above do not limit the disclosure according to Claims. Further, it should be noted that all combinations of features described in the embodiment may not necessarily be essential to the means for solving the problem of the disclosure.

Further, the present disclosure can be carried out by appropriately modifying the present disclosure by omitting some configurations or adding or replacing configurations within a range that does not deviate from the gist of the present disclosure. For example, the above embodiment describes a case where the thrust roller bearing 2 is placed between the disk surface 143b of the second disk portion 143 of the carrier 14 and the second axial end surface 13b of the planetary gear 13. However, the thrust roller bearing 2 may not be used, provided that a thrust force generated in the planetary gear 13 is directed only toward the first disk portion 142.

Further, the above embodiment describes a case where the resin member 40 is molded by injecting molten resin into the cavity of the metal mold from three places. However, the present disclosure is not limited to this, and the gate via which molten resin is injected may be provided at one place or two places or may be provided at four places or more. Further, the cage and the radial-thrust integrated bearing of the present disclosure may be usable in various devices other than the planetary gear device.

What is claimed is:

1. A cage comprising:
a first holding portion in which a plurality of radial rollers is held;
a second holding portion in which a plurality of thrust rollers is held; and
a connecting portion via which the first holding portion is connected to the second holding portion, wherein the first holding portion, the second holding portion, and the connecting portion are molded integrally by a resin member.

2. The cage according to claim 1, wherein:
the first holding portion is defined by axially connecting a pair of annular bodies to each other by a plurality of columns;
the connecting portion is defined to project radially from one of the annular bodies; and
welds caused when the resin member is molded are reinforced by the connecting portion.

3. The cage according to claim 2, wherein the connecting portion has through-holes extending axially and provided at positions deviating from circumferential positions of the welds.

4. A radial-thrust integrated bearing comprising:
the cage according to claim 1;
the radial rollers held in the first holding portion; and
the thrust rollers held in the second holding portion.

5. A planetary gear device comprising:
a sun gear having external teeth provided on an outer peripheral surface of the sun gear;
an internal gear having internal teeth provided on an inner peripheral surface of the internal gear;
a plurality of planetary gears placed between the sun gear and the internal gear; and
a carrier configured to support the planetary gears, wherein the planetary gears are supported by the radial-thrust integrated bearing according to claim 4 such that the planetary gears are rotatable to the carrier.
